(19) United States
(12) Patent Application Publication
(10) Pub. No.: US 2014/0071357 A1
(43) Pub. Date: Mar. 13, 2014

(54) TOUCH PANEL AND MANUFACTURING METHOD THEREOF

(71) Applicant: RTR-TECH TECHNOLOGY CO., LTD., TAINAN (TW)

(72) Inventors: HSIAO - WEN KUO, TAINAN (TW); WEI - CHUAN CHEN, TAINAN (TW)

(73) Assignee: RTR-TECH TECHNOLOGY CO., LTD., TAINAN (TW)

(21) Appl. No.: 14/022,363

(22) Filed: Sep. 10, 2013

(30) Foreign Application Priority Data
Sep. 13, 2012 (TW) 101133525

(51) Int. Cl. G06F 1/16

(52) U.S. Cl. CPC G06F 1/1643
USPC 349/12; 29/846

(57) ABSTRACT

The present invention relates to a touch panel. The touch panel includes a display unit, a transparent substrate disposed on top of the display unit, multiple sensing series disposed on the transparent substrate, multiple peripheral circuits disposed on the transparent substrate, each being electrically connected to a corresponding one of the sensing series, and an outer frame for holding the display unit and the transparent substrate along their peripheries and for masking the peripheral circuits.

### CROSS-REFERENCE TO RELATED APPLICATION

This application claims priority to R.O.C. Patent Application No. 101133525, filed Sep. 13, 2012, the disclosure of which is incorporated herein by reference in its entirety.

### BACKGROUND OF THE INVENTION

1. Field of the Invention

The present invention relates to a touch panel and, more particularly, to a touch panel having a broadened displayable region. The present invention further relates to a method for manufacturing the touch panel.

2. Description of the Prior Art

In the market of consumer electronic products, touch panels have been widely applied in various portable electronic products, such as personal digital assistants (PDAs), mobile phones, laptop computers and tablet computers, to serve as an interface tool for data communication. Meanwhile, as the current trend of designing electronic products leans to meet strong demands for lightweight, slimness and minimization, the electronic products thus designed are often too compact to accommodate conventional input devices, such as a keyboard or a computer mouse. More particularly, in a tablet computer with a user friendly design, a touch panel has become a crucial component. In addition to have the capability of displaying a responsive multi-level menu, a touch panel is adapted to present many user-friendly operation modes, including the cursor function traditionally executed by a keyboard or a computer mouse, the handwriting input function, and so on. Especially, the touch panel has the advantage of integrating the input function and the output function in a same interface (screen) and this advantage cannot be achieved by the conventional input devices.

In the current design of a touch panel, peripheral circuits (composed of metal traces) are laid out along the periphery of the displayable region and serve to transmit the sensing signals from the displayable region to gold finger pads, from which the signals will then be transferred to the motherboard via a flexible printed circuit (FPC) that is electrically connected to the gold finger pads.

Given the increasing demands for visual appeal and product aesthetics in designing touch panel products, efforts have been made to mask the metal trances of the peripheral circuits by printing a patterned masking layer (or a light-shielding layer) on the cover lens. However, the conventional processes are shown to have some serious drawbacks, including low productivity, high manufacture cost, poor smoothness caused by the printed masking layer, occurrence of poor electrical transmission or open circuit in the subsequent process of laying out the sensing wires, and reduced reliability due to cross-connecting the wires.

### SUMMARY OF THE INVENTION

Accordingly, an object of the invention is to provide a touch panel architecture having a simplified structure and a broadened displayable region.

In order to achieve the object described above, the touch panel according to the invention comprises a display unit, a transparent substrate disposed on top of the display unit, a plurality of sensing series disposed on the transparent substrate, a plurality of peripheral circuits disposed on the transparent substrate, each being electrically connected to the sensing series corresponding thereto, and an outer frame for holding the display unit and the transparent substrate along their peripheries and for masking the peripheral circuits. By virtue of the structural arrangement described above, the invention provides a broadened displayable region as compared to the prior art. Moreover, the texture and shape of the outer frame may be widely varied, so as to facilitate the aesthetic experiences for the user.

Another object of the invention is to provide methods for manufacturing a touch panel having a broadened displayable region.

In order to achieve the object described above, a manufacturing method according to the invention comprises the steps of:

providing a transparent substrate;

forming a transparent conductive layer and a metallic layer on the transparent substrate;

patterning the transparent conductive layer and the metallic layer to form a plurality of sensing series and a plurality of peripheral circuits electrically connected to the sensing series;

laminating the transparent substrate onto a display unit; and

providing an outer frame to hold the display unit and the transparent substrate along their peripheries, thereby masking the peripheral circuits.

In order to achieve the object described above, another manufacturing method according to the invention comprises the steps of:

providing a transparent substrate;

forming a transparent conductive layer on the transparent substrate;

patterning the transparent conductive layer to form a plurality of sensing series;

printing a plurality of peripheral circuits on the transparent substrate, so that the peripheral circuits are electrically connected to the sensing series;

laminating the transparent substrate onto a display unit; and

providing an outer frame to hold the display unit and the transparent substrate along their peripheries, thereby masking the peripheral circuits.

### BRIEF DESCRIPTION OF THE DRAWINGS

The above and other objects, features and effects of the invention will become apparent with reference to the following description of the preferred embodiments taken in conjunction with the accompanying drawing, in which:

FIG. 1 is a schematic diagram showing the touch panel structure according to the first preferred embodiment of the invention;

FIG. 2a is a schematic diagram showing the touch panel structure according to the second preferred embodiment of the invention;

FIG. 2b is a schematic diagram showing the touch panel structure according to the third preferred embodiment of the invention;

FIGS. 3a-3e show the manufacturing of the touch panel according to an embodiment of the invention; and

FIGS. 4a-4e show the manufacturing of the touch panel according to another embodiment of the invention.

### DETAILED DESCRIPTION OF THE PREFERRED EMBODIMENTS

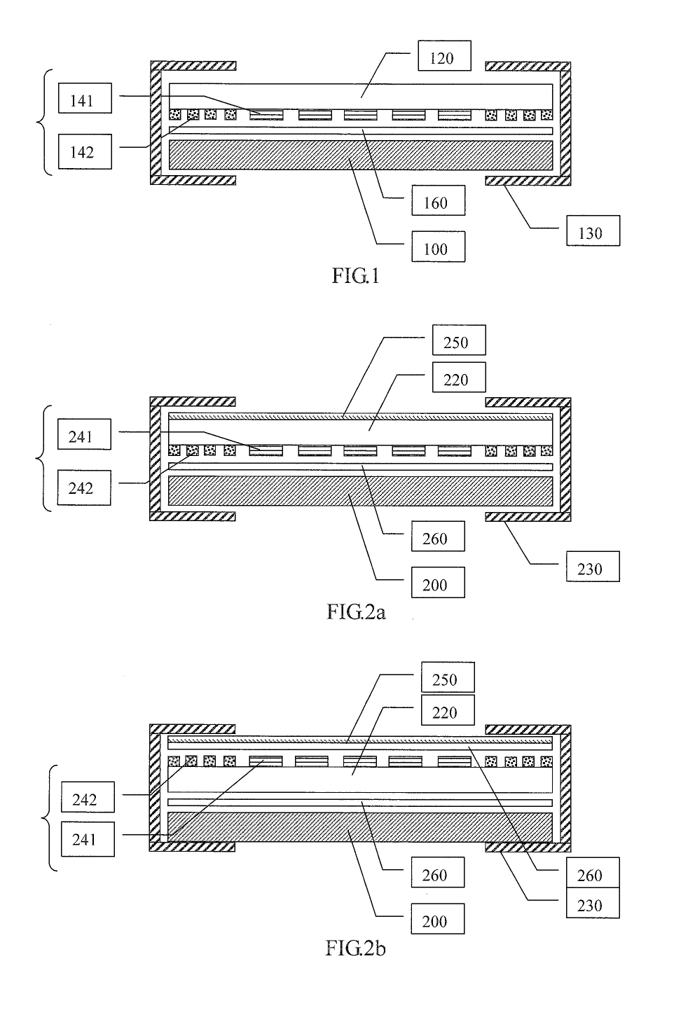

FIG. 1 is a schematic diagram showing the touch panel structure according to the first preferred embodiment of the invention. As illustrated, the invented touch panel comprises a display unit 100, such as a liquid crystal display module or an active-matrix organic light-emitting diode (AMOLED). A transparent substrate, which may by way of example be a polarizer 120, is mounted on top of the display unit 100 and adapted to polarize light to thereby control the display performance. The polarizer 120 is formed on its lower surface with a plurality of sensing series 141 and a plurality of peripheral circuits 142. The respective sensing series 141 are electrically connected to a corresponding one of the peripheral circuits 142.

By way of example, the sensing series 141 may comprise a plurality of first sensing series extending in a first direction and a plurality of second sensing series extending in a second direction. The first sensing series and the second sensing series are electrically insulated from each other and arranged in an alternate manner. Conventional techniques, such as bridge wiring, jump wiring, adding an insulation component, designing a conductive bridge and so on, may be utilized to build up the touch panel structure. Alternatively, the sensing series 141 are composed of a plurality of sensing series extending in a first direction to carry out the touch sensing operation. The touch panel structure disclosed herein further comprises an outer frame 130 for holding the display unit 100 and the polarizer 120 in position and for shielding the peripheral circuits 142, so that the peripheral circuits 142 are not exposed to the outside. The touch panel structure disclosed herein has a light-weight, slim configuration and satisfies the aesthetic demands. In a more preferred embodiment, the polarizer 120 and the display unit 100 are laminated together with an adhesive layer 160. The adhesive layer 160 is selected from an optically clear adhesive, an aqueous adhesive or a combination thereof. The display unit may further comprise a lower polarizer and a backlight unit, so that the light emitted from the backlight unit is initially polarized by the lower polarizer and then polarized by the polarizer 120 laminated on the display unit 100, thereby displaying desired images to the viewer.

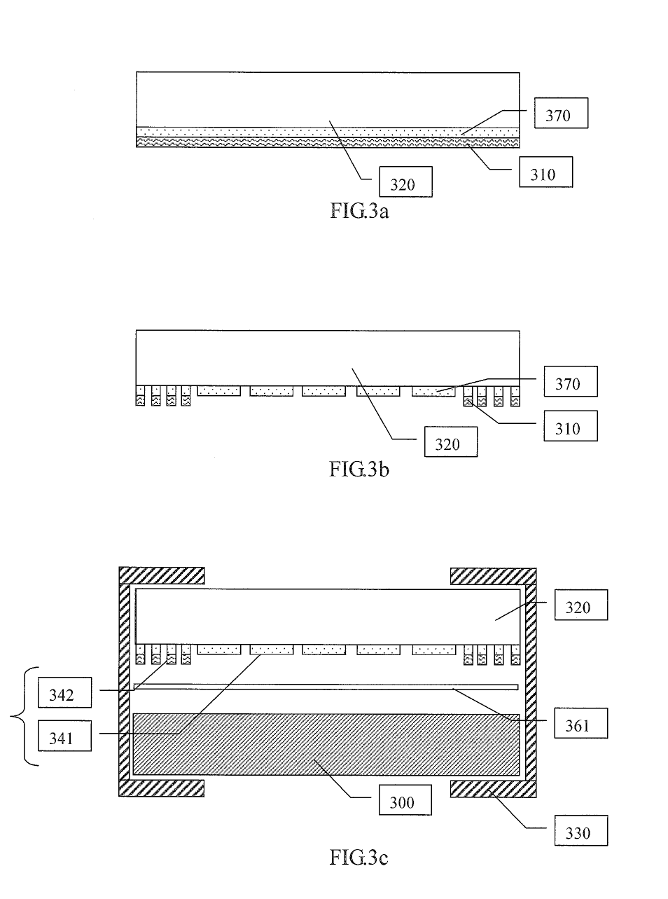

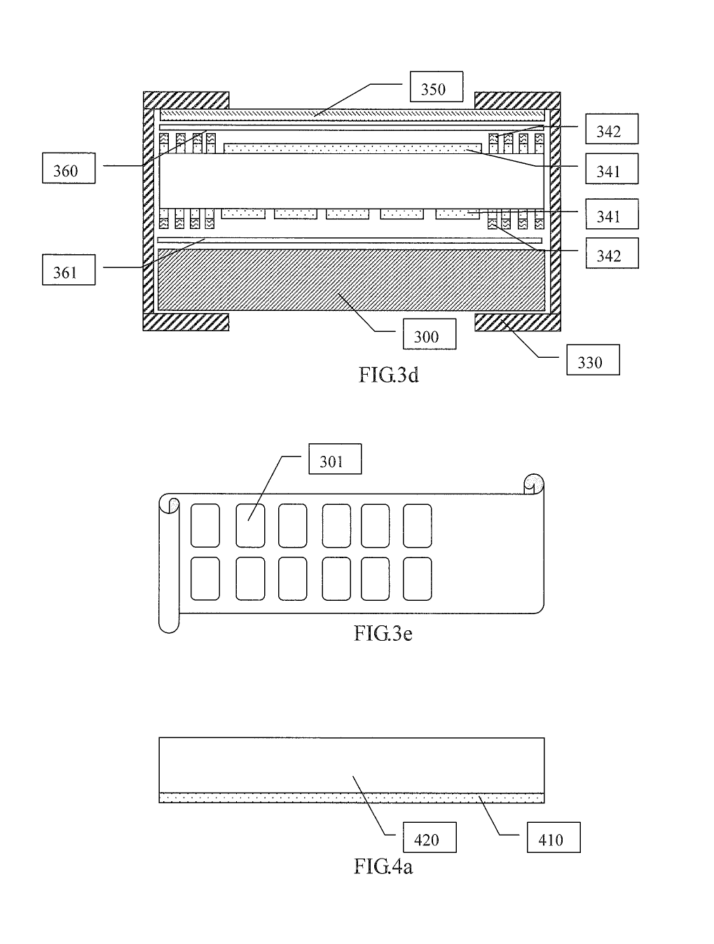

FIG. 2a is a schematic diagram showing the touch panel structure according to the second preferred embodiment of the invention. As illustrated, the touch panel comprises a display unit 200, such as a liquid crystal display module or an AMOLED. A transparent substrate, which may by way of example be a polarizer 220, is mounted on top of the display unit 200 and adapted to polarize light to thereby control the display performance. The polarizer 220 is formed on its lower surface with a plurality of sensing series 241 and a plurality of peripheral circuits 242. The respective sensing series 241 are electrically connected to a corresponding one of the peripheral circuits 242. The sensing series 241 may comprise a plurality of first sensing series extending in a first direction and a plurality of second sensing series extending in a second direction. The first sensing series and the second sensing series are electrically insulated from each other and arranged in an alternate manner. Conventional techniques, such as bridge wiring, jump wiring, adding an insulation component, designing a conductive bridge and so on, may be utilized to build up the touch panel structure. A transparent protective substrate 250 is mounted atop the polarizer 220 and serves as a cover lens providing protection to the touch panel. Preferably, the transparent protective substrate 250 is made of glass, tempered glass, polycarbonate (PC), polymethylmethacrylate (PMMA), or a composite material of PC and PMMA. The touch panel structure disclosed herein further comprises an outer frame 230 for holding the display unit 200, the polarizer 220 and the transparent protective substrate 250 in position and for shielding the peripheral circuits 242, so that the peripheral circuits 242 are not exposed to the outside. The touch panel structure disclosed herein has a light-weight, slim configuration and satisfies the aesthetic demands.

According to third embodiment of the invention shown in FIG. 2b, the sensing series 241 and the peripheral circuits 242 described above may be mounted on either the upper surface or the lower surface of the polarizer 220. The respective sensing series 241 are electrically connected to a corresponding one of the peripheral circuits 242. The sensing series 241 may comprise a plurality of first sensing series extending in a first direction and a plurality of second sensing series extending in a second direction. The first sensing series and the second sensing series are electrically insulated from each other and arranged in an alternate manner. For example, the first sensing series are mounted on the upper surface of the polarizer 220, whereas the second sensing series are mounted on the lower surface of the polarizer 220. Alternatively, the first sensing series and the second sensing series are mounted on the same surface of the polarizer 220. Conventional techniques, such as bridge wiring, jump wiring, adding an insulation component, designing a conductive bridge and so on, may be utilized to build up the touch panel structure.

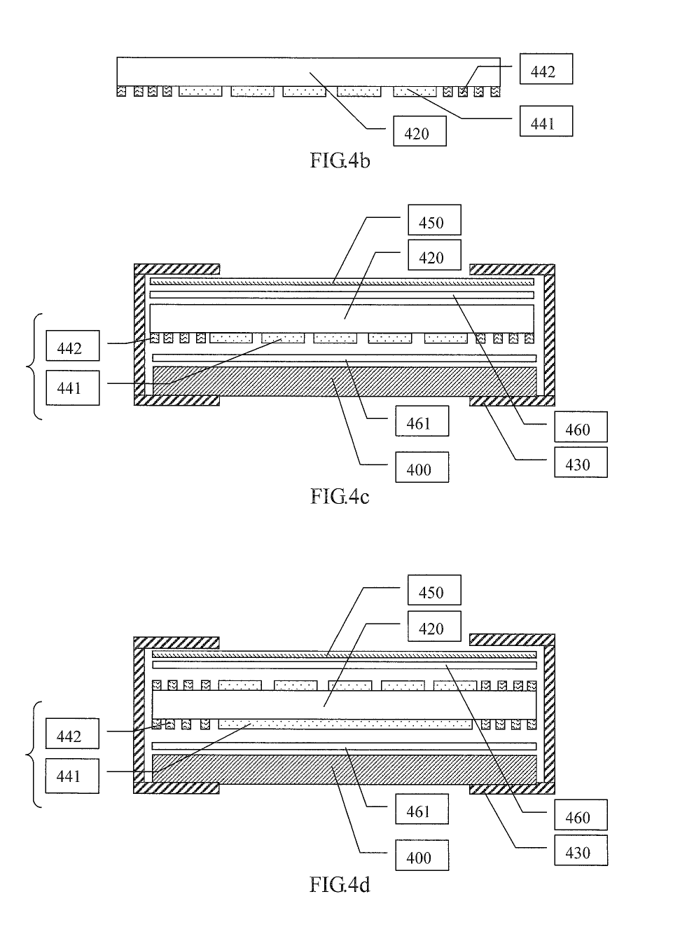

FIGS. 3a-3e show a method for manufacturing a touch panel according to a preferred embodiment of the invention. The method comprises sequentially forming a transparent conductive layer 310 and a metallic layer 370 on a transparent substrate (which may by way of example be a polarizer 320). The transparent conductive layer 310 and the metallic layer 370 are independently formed by the same or different processes, such as by a roll-to-roll physical vapor deposition (PVD) process, a roll-to-roll chemical vapor deposition (CVD) process, a roll-to-roll electroplating process and a roll-to-roll coating process. The transparent conductive layer 310 is made of, for example, a metal oxide, a silver nanowire or a nano-scale conductive metal material. Preferably, the metal oxide is selected from the group consisting of indium tin oxide (ITO), indium zinc oxide (IZO), cadmium tin oxide (CTO), aluminum zinc oxide (AZO), indium tin zinc oxide (ITZO), zinc oxide, cadmium oxide, hafnium oxide (HfO), indium gallium zinc oxide (InGaZnO), indium gallium zinc magnesium oxide (InGaZnMgO), indium gallium magnesium oxide (InGaMgO) and indium gallium aluminum oxide (InGaAlO). The metallic layer 370 comprises one or more layers of conductive metal material, which includes but is not limited to a copper alloy, an aluminum alloy, gold, silver, aluminum, copper and molybdenum. In the case where the metallic layer 370 comprises multiple layers of conductive metal material, the metallic layer 370 is preferably configured in the form of a multi-layer stack structure, with each layer being independently made of a copper alloy, an aluminum alloy, gold, silver, aluminum, copper, molybdenum or a combination thereof. More preferably, the metallic layer 370 is configured in the form of a multi-layer stack structure having an aluminum layer sandwiched by two molybdenum layers. Afterwards, a plurality of sensing series 341 and a plurality of peripheral circuits 342 are formed on the lower surface of the polarizer 320 by a roll-to-roll photolithographic process or a roll-to-roll laser process. The sensing series 341 thus formed may comprise, for example, a plurality of first sensing series extending in a first direction and a plurality of second sensing series extending in a second direction. The first sensing series and the second sensing series are electrically insulated from each other and arranged in an alternate manner. Conventional techniques, such as bridge wiring, jump wiring, adding an insulation component, designing a conductive bridge and so on, may be utilized to build up the sensing series. In one embodiment, the first sensing series are mounted on the upper surface of the polarizer 320, whereas the second sensing series are mounted on the lower surface of the polarizer 320. In an alternative embodiment, the first sensing series and the second sensing series are mounted on the same surface of the polarizer 320. The polarizer 320 is then attached with a second adhesive layer 361 by a roll-to-roll lamination process or a sheet-by-sheet lamination process. Preferably, the second adhesive layer 361 is selected from an optically clear adhesive, an aqueous adhesive or a combination thereof. The resultant structure is sliced into several sheets of touch sensors 301 using a cutting mould or by a laser dicing process. The polarizer 320 formed with the touch sensor 301 is then laminated onto the display unit 300 via a second adhesive layer 361. The structure thus obtained is then held along its periphery by an outer frame 330, so that the polarizer 320 and the display unit 300 are fastened in position and the peripheral circuits 342 is masked, thereby preventing the metallic shine produced by the peripheral circuits 342 from being exposed to the outside and providing excellent visual appeal. The touch panel disclosed herein also satisfies the demands for slimness and light weight. The display unit 300 is preferably a liquid crystal display module or an AMOLED.

In the embodiment described above, after the polarizer 320 is laminated onto the display unit 300, a transparent protective substrate 350 may additionally be laminated onto the polarizer 320 to serve as a cover lens. Preferably, the transparent protective substrate 350 is made of glass, tempered glass, polycarbonate (PC), polymethylmethacrylate (PMMA), or a composite material of PC and PMMA. The lamination of the transparent protective substrate 350 to the polarizer 320 may be carried out by attaching a first adhesive layer 360 to the polarizer 320 by a roll-to-roll lamination process or a sheet-by-sheet lamination process and then laminating the transparent protective substrate 350 to the polarizer 320 via the first adhesive layer 360. Preferably, the first adhesive layer 360 is selected from an optically clear adhesive, an aqueous adhesive or a combination thereof.

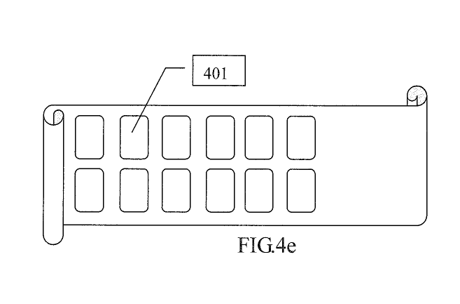

FIGS. 4a-4e show a method for manufacturing a touch panel according to another preferred embodiment of the invention. The method comprises forming a transparent conductive layer 410 on a transparent substrate (which may by way of example be a polarizer 420) by, for example, a roll-to-roll physical vapor deposition (PVD) process, a roll-to-roll chemical vapor deposition (CVD) process, a roll-to-roll electroplating process and a roll-to-roll coating process. The transparent conductive layer 410 is made of, for example, a metal oxide, a silver nanowire or a nano-scale conductive metal material. Preferably, the metal oxide is selected from the group consisting of indium tin oxide (ITO), indium zinc oxide (IZO), cadmium tin oxide (CTO), aluminum zinc oxide (AZO), indium tin zinc oxide (ITZO), zinc oxide, cadmium oxide, hafnium oxide (HfO), indium gallium zinc oxide (InGaZnO), indium gallium zinc magnesium oxide (InGaZnMgO), indium gallium magnesium oxide (InGaMgO) and indium gallium aluminum oxide (InGaAlO). The transparent conductive layer 410 is then patterned by a roll-to-roll photolithographic process or a roll-to-roll laser process, whereby a plurality of sensing series 441 are formed. The sensing series 441 thus formed may comprise, for example, a plurality of first sensing series extending in a first direction and a plurality of second sensing series extending in a second direction. The first sensing series and the second sensing series are electrically insulated from each other and arranged in an alternate manner. Conventional techniques, such as bridge wiring, jump wiring, adding an insulation component, designing a conductive bridge and so on, may be utilized to buildup the sensing series. Alternatively, the sensing series 441 are composed of a plurality of sensing series extending in a first direction to carry out the touch sensing operation. Afterwards, a plurality of peripheral circuits 442 are formed on the polarizer 420 in such a manner that the respective peripheral circuits 442 are electrically connected to the sensing series 441 corresponding thereto. Conventional techniques, such as ink-jet printing, screen printing, precision coating printing and relief printing, may be used for forming the peripheral circuits 442. The polarizer 420 is then attached with a second adhesive layer 461 by a roll-to-roll lamination process or a sheet-by-sheet lamination process. Preferably, the second adhesive layer 461 is selected from an optically clear adhesive, an aqueous adhesive or a combination thereof. The resultant structure is sliced into several sheets of touch sensors 401 using a cutting mould or by a laser dicing process. The polarizer 420 formed with the touch sensor 401 is then laminated onto the display unit 400 via a second adhesive layer 461. The structure thus obtained is then held along its periphery by an outer frame 430, so that the polarizer 420 and the display unit 400 are fastened in position and the peripheral circuits 442 is masked, thereby preventing the metallic shine produced by the peripheral circuits 442 from being exposed to the outside and providing excellent visual appeal. The touch panel disclosed herein also satisfies the demands for slimness and light weight. The display unit 400 is preferably a liquid crystal display module or an AMOLED.

In the manufacturing method described above, the formation of the transparent conductive layer and the metallic layer on the transparent substrate is carried out by a roll-to-roll sputtering process or a roll-to-roll coating process. Preferably, the formation of the transparent conductive layer on the transparent substrate is readily performed by a technique known in the art, such as by sputtering, evaporation deposition, vacuum ion plating, electroplating, physical vapor deposition (PVD), chemical vapor deposition (CVD), spin coating and slit coating.

In the embodiment described above, after the polarizer 420 is laminated onto the display unit 400, a transparent protective substrate 450 may additionally be laminated onto the polarizer 420 to serve as a cover lens. Preferably, the transparent protective substrate 450 is made of glass, tempered glass, polycarbonate (PC), polymethylmethacrylate (PMMA), or a composite material of PC and PMMA. The lamination of the transparent protective substrate 450 to the polarizer 420 may be carried out by attaching a first adhesive layer 460 to the polarizer 420 by a roll-to-roll lamination process or a sheet-by-sheet lamination process and then laminating the transparent protective substrate 450 to the polarizer 420 via the first adhesive layer 460. Preferably, the first adhesive layer 460 is selected from an optically clear adhesive, an aqueous adhesive or a combination thereof.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A touch panel, comprising:
a display unit;
a transparent substrate disposed on top of the display unit;
a plurality of sensing series disposed on the transparent substrate;
a plurality of peripheral circuits disposed on the transparent substrate, with the respective peripheral circuits being electrically connected to a corresponding one of the sensing series; and
an outer frame for holding the display unit and the transparent substrate along their peripheries and for masking the peripheral circuits.

2. The touch panel according to claim 1, wherein the transparent substrate and the display unit sandwich an adhesive layer.

3. The touch panel according to claim 1, wherein the sensing series further comprises a plurality of first sensing series extending in a first direction and a plurality of second sensing series extending in a second direction, with the first sensing series and the second sensing series being arranged in an alternate manner.

4. The touch panel according to claim 1, further comprising a transparent protective substrate mounted on the transparent substrate.

5. The touch panel according to claim 1, wherein the transparent substrate is a polarizer.

6. The touch panel according to claim 2, wherein the transparent substrate is a polarizer.

7. The touch panel according to claim 3, wherein the transparent substrate is a polarizer.

8. A method for manufacturing a touch panel, comprising the steps of:
providing a transparent substrate;
forming a transparent conductive layer and a metallic layer on the transparent substrate;
patterning the transparent conductive layer and the metallic layer to form a plurality of sensing series and a plurality of peripheral circuits electrically connected to the sensing series;
laminating the transparent substrate onto a display unit; and
providing an outer frame to hold the display unit and the transparent substrate along their peripheries, thereby masking the peripheral circuits.

9. The method according to claim 8, wherein the formation of the sensing series further comprises forming a plurality of first sensing series extending in a first direction and a plurality of second sensing series extending in a second direction, with the first sensing series and the second sensing series being arranged in an alternate manner.

10. The method according to claim 8, wherein the formation of the transparent conductive layer and the metallic layer on the transparent substrate is carried out by a roll-to-roll sputtering process or a roll-to-roll coating process.

11. The method according to claim 8, wherein the patterning of the transparent conductive layer and the metallic layer is carried out by a roll-to-roll photolithographic process or a roll-to-roll laser etching process.

12. The method according to claim 8, further comprising a step of mounting a transparent protective substrate on the transparent substrate.

13. The method according to claim 8, wherein the transparent substrate is a polarizer.

14. A method for manufacturing a touch panel, comprising the steps of:
providing a transparent substrate;
forming a transparent conductive layer on the transparent substrate;
patterning the transparent conductive layer to form a plurality of sensing series;
printing a plurality of peripheral circuits on the transparent substrate, so that the peripheral circuits are electrically connected to the sensing series;
laminating the transparent substrate onto a display unit; and
providing an outer frame to hold the display unit and the transparent substrate along their peripheries, thereby masking the peripheral circuits.

15. The method according to claim 14, wherein the formation of the sensing series further comprises forming a plurality of first sensing series extending in a first direction and a plurality of second sensing series extending in a second direction, with the first sensing series and the second sensing series being arranged in an alternate manner.

16. The method according to claim 14, wherein the formation of the transparent conductive layer and the metallic layer on the transparent substrate is carried out by a roll-to-roll sputtering process or a roll-to-roll coating process.

17. The method according to claim 14, wherein the patterning of the transparent conductive layer and the metallic layer is carried out by a roll-to-roll photolithographic process or a roll-to-roll laser etching process.

18. The method according to claim 14, further comprising a step of mounting a transparent protective substrate on the transparent substrate.

19. The method according to claim 14, wherein the transparent substrate is a polarizer.
